(19) United States
(12) Patent Application Publication
(10) Pub. No.: US 2026/0068011 A1
(43) Pub. Date: Mar. 5, 2026

(54) LIGHT-EMITTING ELEMENT DRIVING DEVICE, LIGHT-EMITTING SYSTEM, BACKLIGHT, AND DISPLAY DEVICE

(71) Applicant: ROHM CO., LTD., KYOTO (JP)

(72) Inventor: Keisuke MIURA, KYOTO (JP)

(21) Appl. No.: 19/304,719

(22) Filed: Aug. 20, 2025

(30) Foreign Application Priority Data
Aug. 27, 2024 (JP) 2024-145518

(51) Int. Cl. H05B 45/46

(52) U.S. Cl. CPC H05B 45/46

(57) ABSTRACT

A light-emitting element driving device includes a monitoring section that monitors a voltage of a connection terminal with a driving current in an on state and holds a monitoring result; an output section that outputs a terminal voltage detection signal indicating whether a voltage of the connection terminal of at least one channel is lower than a reference voltage based on the held monitoring result; an output terminal that outputs the terminal voltage detection signal to an outside; an input terminal; and a control signal generation section that generates a control signal used for feedback control of a power supply circuit that generates a power supply voltage based on a signal input to the input terminal and the held monitoring result, wherein the on state of the driving current is controlled during one period of a synchronization signal, and the control signal generation section updates the control signal when the next period of the synchronization signal starts.

### TECHNICAL FIELD

The present disclosure relates to a light-emitting element driving device.

### BACKGROUND

Conventionally, Patent Document 1 discloses a light-emitting element driving device that comprises connection terminals for multiple channels to be connected to a light-emitting section formed of one or more light-emitting elements, and is configured to be able to supply a driving current to the light-emitting section through the connection terminals for each channel.

### PRIOR ART DOCUMENT

### Patent Document

[Patent document 1] International Publication No. WO 2022/153668.

### BRIEF DESCRIPTION OF THE DRAWINGS

FIG. 1 is a diagram showing a configuration of a light-emitting system.

FIG. 2 is a diagram showing an example of a light-emitting system configured using multiple light-emitting element driving devices.

FIG. 3 is a diagram showing an example of a system using multiple light-emitting element driving devices according to a comparative example.

FIG. 4 is a diagram showing a configuration example of a FB current generation section.

FIG. 5 is a timing chart showing a first operation example in a system using a light-emitting element driving device according to a comparative example.

FIG. 6 is a timing chart showing a second operation example in a system using a light-emitting element driving device according to a comparative example.

FIG. 7 is a diagram showing an example of a system using multiple light-emitting element driving devices according to a first embodiment.

FIG. 8 is a timing chart showing a first operation example in a system using a light-emitting element driving device according to the first embodiment.

FIG. 9 is a timing chart showing a second operation example in a system using a light-emitting element driving device according to the first embodiment.

FIG. 10 is a diagram showing an example of a system using multiple light-emitting element driving devices according to a second embodiment.

FIG. 11 is a diagram showing an example of a system using multiple light-emitting element driving devices according to a third embodiment.

FIG. 12 is a diagram showing a configuration of a light-emitting system using a light-emitting element driving device according to a fourth embodiment.

FIG. 13 is a diagram showing an internal configuration in the light-emitting element driving device 1 according to the fourth embodiment.

FIG. 14 is a diagram illustrating a time-division light-emitting operation.

FIG. 15 is a diagram showing a configuration example of a liquid crystal display device.

FIG. 16 is a diagram showing an example of an in-vehicle display.

### DETAILED DESCRIPTION OF THE EMBODIMENTS

Hereinafter, exemplary embodiments of the present disclosure are illustrated with reference to figures.

### <Light-Emitting Systems>

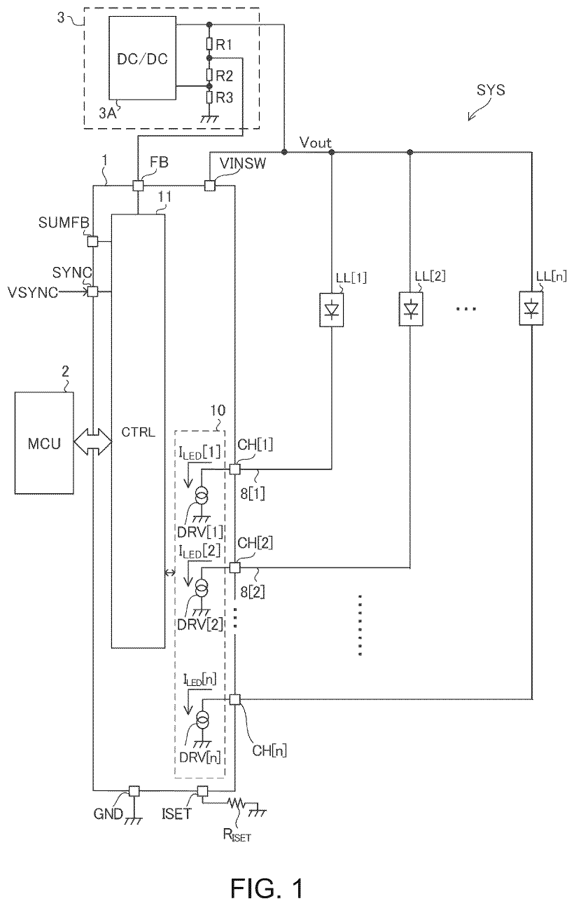

FIG. 1 is a diagram showing a configuration of a light-emitting system SYS. The light-emitting system SYS comprises a light-emitting element driving device 1, an MCU (Micro Controller Unit) 2 that controls the light-emitting element driving device 1, multiple light-emitting sections LL driven by the light-emitting element driving device 1, and a power supply circuit 3 that outputs a power supply voltage Vout. The power supply voltage Vout is a positive direct current voltage. The light-emitting element driving device 1 comprises a terminal VINSW that receives the power supply voltage Vout as an external terminal and is driven based on the power supply voltage Vout. Furthermore, a current setting resistor R_{ISET} is also included as a component of the light-emitting system SYS.

The light-emitting element driving device 1 is a semiconductor device configured to be able to drive light-emitting sections LL[1] to LL[n] of multiple channels (n channels). The light-emitting sections LL[1] to LL[n] each includes one or more light-emitting elements. These light-emitting elements are LEDs (light-emitting diodes) in the example of FIG. 1. Furthermore, in the following illustrations, the light-emitting element is illustrated as an LED as an example. That is, the light-emitting element driving device functions as an LED driving device. Each high potential end (anode) of the light-emitting sections LL[1] to LL[n] is connected to an application end of the power supply voltage Vout.

The light-emitting element driving device 1 comprises connection terminals CH[1] to CH[n] as external terminals for establishing electrical connections with an outside. A low potential end (cathode) of each of the light-emitting sections LL[1] to LL[n] is connected to each of the connection terminals CH[1] to CH[n]. The light-emitting element driving device 1 comprises a driver block 10. The driver block 10 comprises current drivers DRV[1] to DRV[n]. Each of the current drivers DRV[1] to DRV[n] is connected to each of the connection terminals CH[1] to CH[n]. Each of the current drivers DRV[1] to DRV[n] generate driving currents I_{LED}[1] to I_{LED}[n] that flow through each of the light-emitting sections LL[1] to LL[n] via each of the connection terminals CH[1] to CH[n].

The light-emitting element driving device 1 comprises a control block 11. The control block 11 integrally controls an operation of each component within the light-emitting element driving device 1. The control block 11 can individually switch the current drivers DRV[1] to DRV[n] to an on state or an off state. Additionally, the control block 11 has a function of adjusting the power supply voltage Vout output from the power supply circuit 3 through a terminal FB (feedback terminal) based on a terminal voltage of the connection terminals CH[1] to CH[n] during a normal light-emitting operation. Such feedback control is described in detail below.

The light-emitting element driving device 1 comprises a terminal SYNC as an external terminal. A synchronization signal VSYNC is input to the terminal SYNC from an outside. The current drivers DRV[1] to DRV[n] operate based on a rise of a synchronization signal VSYNC.

The light-emitting element driving device 1 comprises a terminal SUMFB as an external terminal. The terminal SUMFB is a terminal used when multiple light-emitting element driving devices 1 are employed, and is specifically illustrated below.

The light-emitting element driving device 1 and the MCU 2 are capable of bidirectional communication through a communication wiring. Through this bidirectional communication, the MCU 2 can transmit any command to the light-emitting element driving device 1, and the light-emitting element driving device 1 can transmit a response signal to the MCU 2 in response to the received command. A communication method between the light-emitting element driving device 1 and the MCU 2 is arbitrary, and may be a method compliant with, for example, SPI (Serial Peripheral Interface).

The light-emitting element driving device 1 is also provided with a terminal GND and a terminal ISET as external terminals. The terminal GND is connected to a ground end (an application end of ground potential). A current setting resistor R_{ISET} is provided outside the light-emitting element driving device 1. One end of the current setting resistor R_{ISET} is connected to the terminal ISET, and the other end of the current setting resistor R_{ISET} is connected to the ground end. The control block 11 can individually set a magnitude of the driving currents I_{LED}[1] to I_{LED}[24] based on a value of the current setting resistor R_{ISET} and a command from the MCU 2.

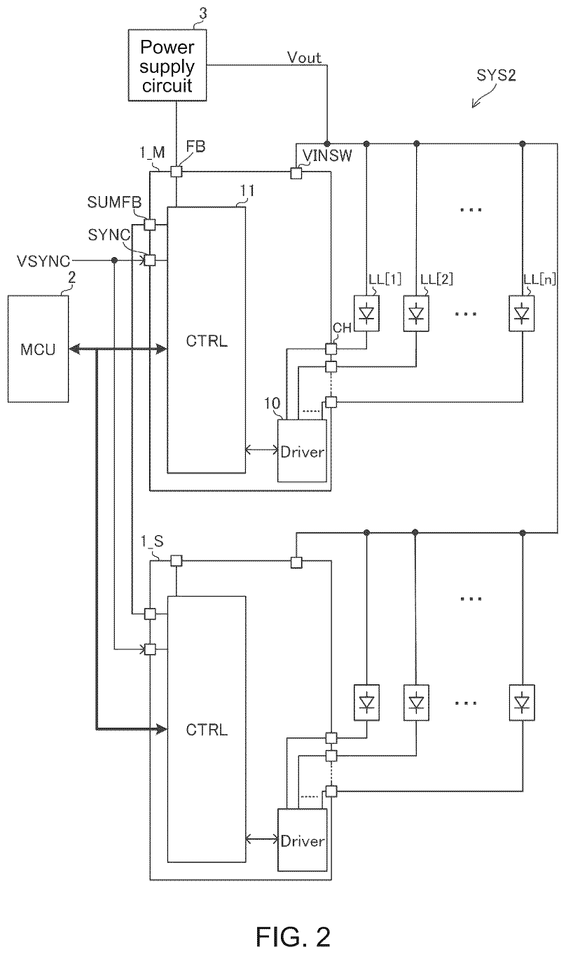

FIG. 2 is a diagram showing an example of a light-emitting system configured using multiple light-emitting element driving devices 1. In FIG. 2, as an example, a light-emitting system SYS2 configured using two light-emitting element driving devices 1 is shown. Among the multiple light-emitting driving devices 1, one functions as a main device, and the others function as sub-devices. That is, configurations of the light-emitting element driving devices 1 are same for both the main and sub-devices. In FIG. 2, a main light-emitting element driving device 1_M and a sub light-emitting element driving device 1_S are provided. The multiple light-emitting element driving devices 1 each drives the light-emitting sections LL[1] to LL[n]. The power supply voltage Vout is applied to a high potential end (anode) of each set of light-emitting sections LL[1] to LL[n].

The MCU 2 performs a communication with the control blocks 11 of each of the light-emitting element driving devices 1_M, 1_S. The synchronization signal VSYNC is input to the terminal SYNC of each of the light-emitting element driving devices 1_M, 1_S. In each of the light-emitting element driving devices 1_M, 1_S, the current drivers DRV[1] to DRV[n] in the driver block 10 operate based on a rise of the synchronization signal VSYNC.

The terminals SUMFB of each of the light-emitting element driving devices 1_M, 1_S are connected. In the sub light-emitting element driving device 1_S, a signal resulting from monitoring the terminal voltages of the connection terminals CH[1] to CH[n] of the light-emitting element driving device 1_S is output to an outside via the terminal SUMFB from the control block 11. In the main light-emitting element driving device 1_M, a signal output from the terminal SUMFB of the light-emitting element driving device 1_S is input to its own terminal SUMFB. The control block 11 in the main light-emitting element driving device 1_M adjusts the power supply voltage Vout of the power supply circuit 3 via the terminal FB based on a result of monitoring the terminal voltages of the connection terminals CH[1] to CH[n] and a signal input to the terminal SUMFB. As a result, the power supply voltage Vout can be adjusted according to the terminal voltages of the connection terminals CH[1] to CH[n] in multiple light-emitting element driving devices 1.

### Comparative Example

Herein, before illustrating embodiments of the present disclosure described below, a comparative example is illustrated for contrast. This makes issues to be resolved more apparent.

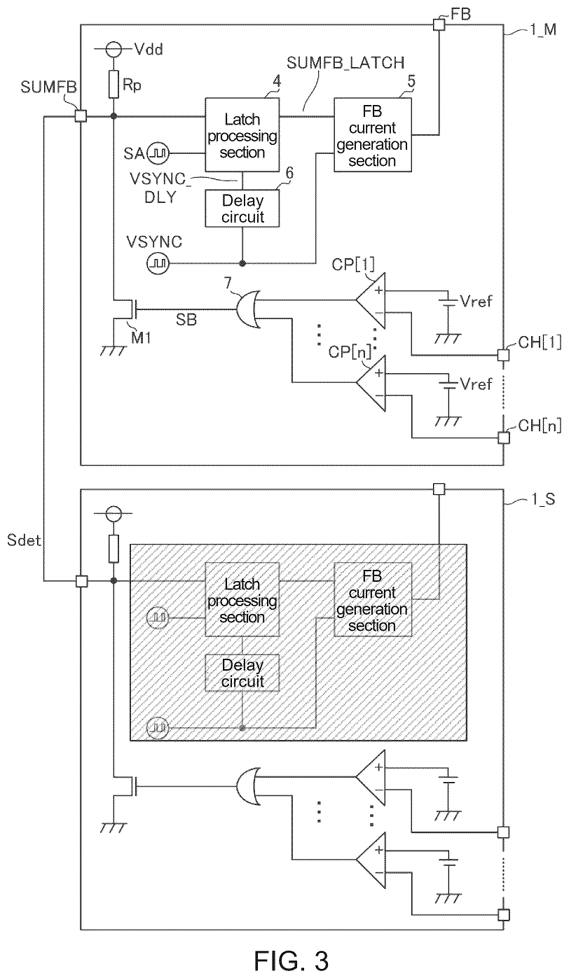

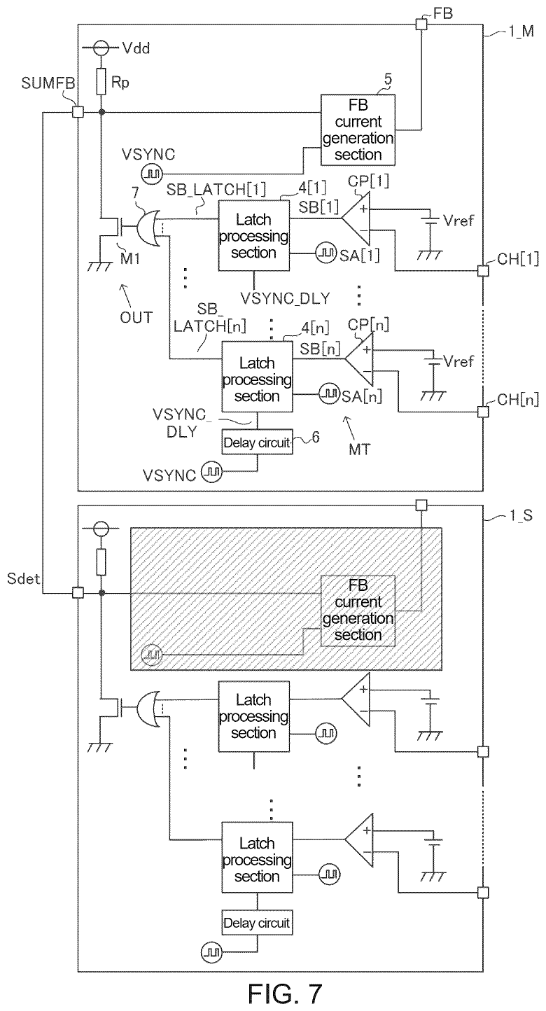

FIG. 3 is a diagram showing an example of a system using multiple light-emitting element driving devices 1 according to the comparative example. In FIG. 3, the main light-emitting element driving device 1_M and the sub light-emitting element driving device 1_S are used. An internal circuit configuration of the light-emitting element driving device 1 shown in FIG. 3 is an internal configuration of the control block 11 (the same applies to FIGS. 7, 10, 11, 13 described below).

The light-emitting element driving device 1 (control block 11) comprises comparators CP[1] to CP[n], an NMOS transistor M1, a pull-up resistor Rp, a latch processing section 4, an FB (feedback) current generation section 5, a delay circuit 6, and an OR gate 7.

An inverting input terminal (−) of each of the comparators CP[1] to CP[n] is connected to each of the connection terminals CH[1] to CH[n]. A non-inverting input terminal (+) of each of the comparators CP[1] to CP[n] is connected to an application end of a reference voltage Vref. As a result, the comparators CP[1] to CP[n] each compares a terminal voltage of each of the connection terminals CH[1] to CH[n] with the reference voltage Vref and outputs a comparison result. This comparison result corresponds to a monitoring result of the terminal voltage of each of the connection terminals CH[1] to CH[n].

An output of each of the comparators CP[1] to CP[n] is input to the OR gate 7. The NMOS transistor M1 is configured using an N-channel type MOSFET (metal-oxide-semiconductor field-effect transistor). A gate of the NMOS transistor M1 is connected to an output end of the OR gate 7. A source of the NMOS transistor M1 is connected to a ground end. A drain of the NMOS transistor M1 is connected to one end of the pull-up resistor Rp and the terminal SUMFB. The other end of the pull-up resistor Rp is connected to an application end of a power supply voltage Vdd. An output section having an open-drain configuration is formed by the NMOS transistor M1.

The terminals SUMFB of each of the main light-emitting element driving device 1_M and the sub light-emitting element driving device 1_S are connected. If at least one terminal voltage of the connection terminals CH[1] to CH[n] in the light-emitting element driving device 1_S is lower than the reference voltage Vref, an output of the OR gate 7 becomes high level, causing the NMOS transistor M1 to be in an on state, and a terminal voltage detection signal Sdet output from the terminal SUMFB becomes low level. In this case, in the main light-emitting element driving device 1_M, a voltage of the terminal SUMFB (terminal voltage detection signal Sdet) becomes low level regardless of states of terminal voltages of the connection terminals CH[1] to CH[n].

On the other hand, if all terminal voltages of the connection terminals CH[1] to CH[n] in the light-emitting element driving device 1_S are equal to or higher than the reference voltage Vref, the output of the OR gate 7 becomes low level, causing the NMOS transistor M1 to be in the off state. In this case, in the main light-emitting element driving device 1_M, a voltage of the terminal SUMFB (terminal voltage detection signal Sdet) becomes low level or high level according to states of the terminal voltages of the connection terminals CH[1] to CH[n].

That is, if at least one terminal voltage of the connection terminals CH[1] to CH[n] in the light-emitting element driving devices 1_M, 1_S is lower than the reference voltage Vref, the voltage of the terminal SUMFB in the light-emitting element driving device 1_M becomes low level, and if all terminal voltages of the connection terminals CH[1] to CH[n] in the light-emitting element driving devices 1_M, 1_S are equal to or higher than the reference voltage Vref, the voltage of the terminal SUMFB in the light-emitting element driving device 1_M becomes high level.

The latch processing section 4, the FB current generation section 5, and the delay circuit 6 become disabled in the sub light-emitting element driving device 1_S (hatched in FIG. 3). The latch processing section 4 latches (holds) the voltage of the terminal SUMFB using a latching signal SA as a trigger. The latch processing section 4 outputs a latch signal SUMFB_LATCH as a latch result.

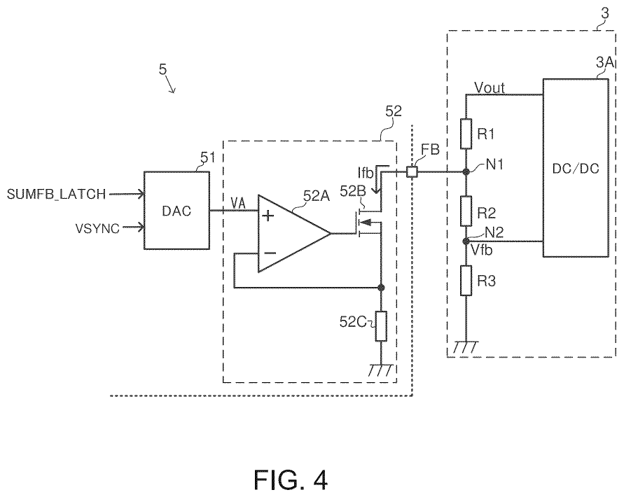

Herein, FIG. 4 shows a configuration example of the FB current generation section 5. The FB current generation section 5 comprises a DAC (DA converter) 51 and a constant current circuit 52. The DAC 51 sets DAC data (digital value) according to the latch signal SUMFB_LATCH and converts the set DAC data into an analog voltage VA to output to the constant current circuit 52. Additionally, the synchronization signal VSYNC is input to the DAC 51. The DAC 51 updates the DAC data using the synchronization signal VSYNC as a trigger.

The constant current circuit 52 generates a FB current Ifb, which is a constant current, according to the analog voltage VA, which serves as a current command value. The FB current Ifb flows through the terminal FB. The constant current circuit 52 comprises an error amplifier 52A, an output transistor 52B, and a resistor 52C. A non-inverting input terminal of the error amplifier 52A is applied with the analog voltage VA output from the DAC 51. An output end of the error amplifier 52A is connected to a gate of the output transistor 52B, which is formed of an N-channel type MOSFET. A source of the output transistor 52B is connected to one end of the resistor 52C along with an inverting input terminal of the error amplifier 52A. The other end of the resistor 52C is connected to a ground end. A drain of the output transistor 52B is connected to the terminal FB.

As shown in FIG. 4, the power supply circuit 3 (also shown in FIG. 1 and FIG. 2) comprises a DC/DC converter 3A and feedback resistors R1 to R3. The feedback resistors R1 to R3 are connected in series between an application end of the power supply voltage Vout output from the DC/DC converter 3A and the ground end. Specifically, the application end of the power supply voltage Vout is connected to one end of the feedback resistor R1. The other end of the feedback resistor R1 is connected to one end of the feedback resistor R2 at a node N1. The other end of the feedback resistor R2 is connected to one end of the feedback resistor R3 at a node N2. The other end of the feedback resistor R3 is connected to the ground end. The node N1 is connected to the terminal FB. With this configuration, the FB current Ifb generated by the constant current circuit 52 according to the analog voltage VA is drawn from the node N1 via the terminal FB. A feedback voltage Vfb is generated at the node N2 according to the FB current Ifb. The DC/DC converter 3A controls the power supply voltage Vout so that the feedback voltage Vfb matches a predetermined reference voltage.

When the latch signal SUMFB_LATCH is at a low level, since at least one terminal voltage of the connection terminals CH[1] to CH[n] in the light-emitting element driving devices 1_M, 1_S is insufficient, the DAC 51 sets DAC data so that the analog voltage VA is higher than the current value when triggered by the synchronization signal VSYNC. As a result, the FB current Ifb increases, and the power supply voltage Vout is adjusted to increase.

On the other hand, when the latch signal SUMFB_LATCH is at a high level, since all the terminal voltages of the connection terminals CH[1] to CH[n] in the light-emitting element driving devices 1_M, 1_S are sufficient, the DAC 51 sets the DAC data so that the analog voltage VA is lower than the current value when triggered by the synchronization signal VSYNC. As a result, the FB current Ifb decreases, and the power supply voltage Vout is adjusted to decrease.

Returning to the illustration in FIG. 3, the delay circuit 6 inputs a synchronization signal VSYNC_DLY, which is obtained by delaying the synchronization signal VSYNC, to the latch processing section 4. The latch processing section 4 releases the latch using the synchronization signal VSYNC_DLY as a trigger.

Herein, the light-emitting element driving device 1 comprises a phase shift function that shifts a timing at which the main and sub light-emitting sections are driven. The issues of the comparative example when such a phase shift function is enabled are illustrated.

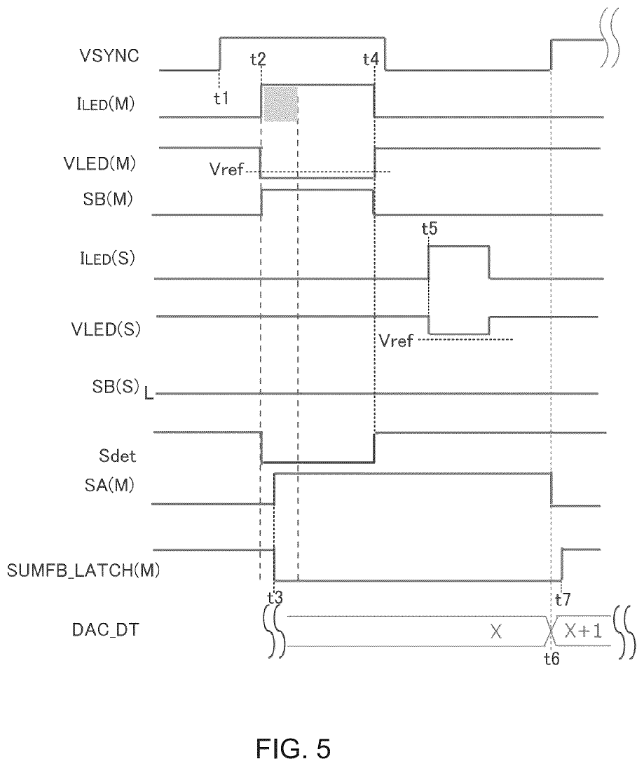

FIG. 5 is a timing chart showing a first operation example in a system using the light-emitting element driving device 1 according to the comparative example shown in FIG. 3. Furthermore, in FIG. 5, in order from the top, the synchronization signal VSYNC, a driving current I_{LED}(M) in the main, a terminal voltage VLED(M) of a connection terminal CH in the main, an output signal SB(M) of the OR gate 7 in the main, a driving current I_{LED}(S) in the sub, a terminal voltage VLED(S) of the connection terminal CH in the sub, an output signal SB(S) of the OR gate 7 in the sub, the terminal voltage detection signal Sdet (voltage of the terminal SUMFB), a latching signal SA(M) in the main, a latch signal SUMFB_LATCH(M) in the main, and DAC data DAC_DT set in the DAC 51 are shown.

First, the synchronization signal VSYNC rises at timing t1. Based on this rise, the driving current I_{LED}(M) and the driving current I_{LED}(S) flow. Herein, due to the phase shift function, a timing at which the driving current I_{LED}(M) and the driving current I_{LED}(S) flow is shifted.

After timing t1, the driving current I_{LED}(M) in the main starts to flow at timing t2. Herein, it is assumed that the driving current I_{LED} flows from timing t2 in all the connection terminals CH[1] to CH[n] in the main. At this time, the terminal voltage VLED(M) of the connection terminal CH in the main decreases. Herein, it is assumed that the terminal voltage VLED(M) in at least one of the connection terminals CH[1] to CH[n] is lower than the reference voltage Vref. As a result, the output signal SB(M) of the OR gate 7 in the main becomes high level, and the terminal voltage detection signal Sdet becomes low level.

The latching signal SA(M) in the main is generated to rise within a predetermined period (hatched) from the timing t1 in a state in which the driving current I_{LED}(M) in the main flows. When the latching signal SA(M) rises (timing t3), the latch processing section 4 in the main latches the terminal voltage detection signal Sdet using this as a trigger. Thus, the latch signal SUMFB_LATCH(M) in the main falls to a low level.

Subsequently, at timing t4, the driving current I_{LED}(M) in the main stops flowing (stop of the driving current), the terminal voltage VLED(M) becomes equal to or higher than the reference voltage Vref, the output signal SB(M) becomes low level, and the terminal voltage detection signal Sdet returns to high level.

Subsequently, at timing t5, the driving current I_{LED}(S) in the sub starts to flow. Herein, it is assumed that the driving current I_{LED} flows from the timing t5 in all the connection terminals CH[1] to CH[n] in the sub. At this time, the terminal voltage VLED(S) of the connection terminal CH in the sub decreases. Herein, it is assumed that all the terminal voltages VLED(S) of the connection terminals CH[1] to CH[n] are equal to or higher than the reference voltage Vref. As a result, the output signal SB(S) of the OR gate 7 in the sub becomes low level, and the terminal voltage detection signal Sdet is kept at the high level.

Subsequently, when the synchronization signal VSYNC rises again at timing t6 (start of the next period of VSYNC), the DAC 51 updates the DAC data using this as a trigger. Herein, since the latch signal SUMFB_LATCH(M) is at a low level, the DAC data is updated to increase the analog voltage VA. As a result, the power supply voltage Vout is adjusted to increase.

The rise of the synchronization signal VSYNC is delayed by the delay circuit 6, and the delayed rise occurs at timing t7. The latch processing section 4 releases the latch using this as a trigger.

As such, in the case example shown in FIG. 5, since it is possible to detect an occurrence of insufficiency of the terminal voltage of the connection terminal CH in the main and latch the terminal voltage detection signal Sdet, this can be reflected when updating the DAC data, which is triggered by the rise of the synchronization signal VSYNC.

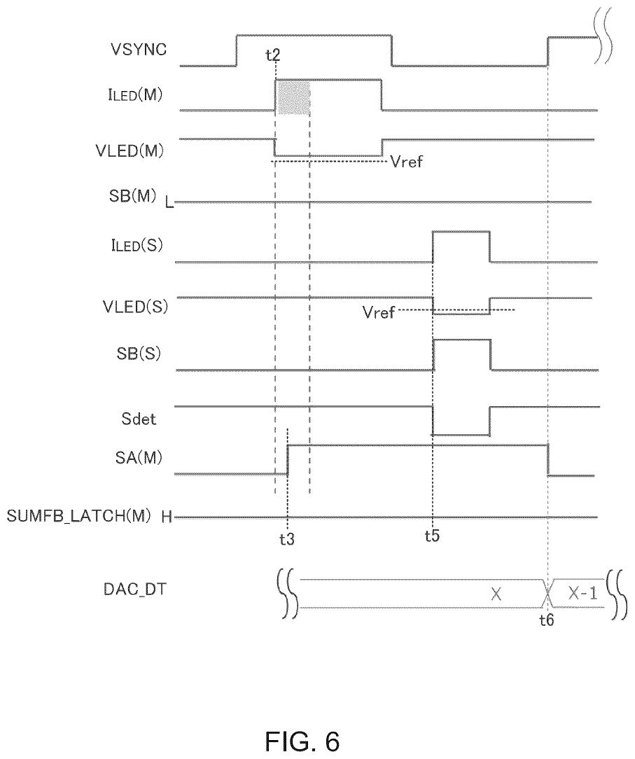

Next, FIG. 6 shows a second operation example in a system using the light-emitting element driving device 1 according to the comparative example shown in FIG. 3. Herein, differences from the case example in FIG. 5 are illustrated. In the case example of FIG. 6, when the driving current I_{LED}(M) in the main flows at the timing t2, the terminal voltage VLED(M) in the main decreases but remains equal to or higher than the reference voltage Vref. As a result, the terminal voltage detection signal Sdet becomes high level, and even if the terminal voltage detection signal Sdet is latched at the timing t3, the latch signal SUMFB_LATCH(M) is kept at the high level.

In FIG. 6, subsequently, when the drive current I_{LED}(S) in the sub flows at the timing t5, the terminal voltage VLED(M) in the sub decreases and becomes lower than the reference voltage Vref. As a result, the terminal voltage detection signal Sdet becomes low level, but since the latch has already been performed, the low level of the terminal voltage detection signal Sdet here is ignored. Thus, at the timing t6 when the synchronization signal VSNC rises, the latch signal SUMFB_LATCH(M) is at a high level, and the DAC data is updated so that the analog voltage VA decreases, and the power supply voltage Vout is adjusted to decrease.

In the configuration according to the comparative example, since the latch can only be performed at the timing when the drive current flows to the connection terminal CH in the main light-emitting element drive device 1_M, as in the case example of FIG. 6, when an insufficiency occurs in the terminal voltage of the connection terminal CH in the sub light-emitting element drive device 1_S, the terminal voltage detection signal Sdet, which is the detection result, cannot be latched, the DAC data update cannot be performed properly, and the power supply voltage Vout cannot be adjusted properly.

### First Embodiment

In view of the above issues, embodiments illustrated below are implemented.

FIG. 7 is a diagram showing an example of a system using multiple light-emitting element drive devices 1 according to a first embodiment. In FIG. 7, the main light-emitting element drive device 1_M and the sub light-emitting element drive device 1_S are used.

The light-emitting element drive device 1 (control block 11) according to this embodiment comprises comparators CP[1] to CP[n], latch processing sections 4[1] to 4[n], an FB current generation section 5, a delay circuit 6, an OR gate 7, an NMOS transistor M1, and a pull-up resistor Rp.

The comparators CP[1] to CP[n] are similar to those in the comparative example, and each compares the terminal voltage of each of the connection terminals CH[l] to CH[n] with the reference voltage Vref and outputs the comparison result. This comparison result corresponds to the monitoring result of the terminal voltages of each of the connection terminals CH[I] to CH[n].

Output signals SB[1] to SB[n] of each of the comparators CP[1] to CP[n] are input to the respective latch processing sections 4[1] to 4[n]. The latch processing sections 4[1] to 4[n] each latches the output signals SB[1] to SB[n] using the latching signals SA[1] to SA[n] as triggers. Each of the latch processing sections 4[1] to 4[n] outputs each of the latch signals SB_LATCH[1] to SB_LATCH[n] as latch results.

An output section OUT comprises the OR gate 7, the NMOS transistor M1, and the pull-up resistor Rp. The latch signals SB_LATCH[l] to SB_LATCH[n] are input to the OR gate 7. An output of the OR gate 7 is input to a gate of the NMOS transistor M1. A connection relationship of the NMOS transistor M1, the pull-up resistor Rp, and the terminal SUMFB is the same as in the comparative example, and the output section OUT is configured with an open-drain configuration by the NMOS transistor ML.

The terminal voltage detection signal Sdet, which is a voltage generated at the terminal SUMFB, is input to the FB current generation section 5. In this embodiment, instead of the latch signal SUMFB_LATCH in FIG. 4, the terminal voltage detection signal Sdet is input to the FB current generation section 5. As a result, the DAC data is updated based on the terminal voltage detection signal Sdet, and the FB current Ifb is generated.

Additionally, the delay circuit 6 is provided in common to the latch processing sections 4[1] to 4[n], and inputs the delayed synchronization signal VSYNC_DLY, which is obtained by delaying the synchronization signal VSYNC, to the latch processing sections 4[1] to 4[n]. The latch processing sections 4[1] to 4[n] release the latch using the synchronization signal VSYNC_DLY as a trigger.

As such, a monitor section MT that monitors the voltage of the connection terminals CH[1] to CH[n] and holds the monitoring results, is configured from the comparators CP[1] to CP[n] and the latch processing sections 4[1] to 4[n]. Furthermore, the delay circuit 6 is also included in the monitor section MT.

In the system shown in FIG. 7, the main light-emitting element drive device 1_M and the sub light-emitting element drive device 1_S, each comprises the above configuration, are connected by connecting their terminals SUMFB to each other. Furthermore, the FB current generation section 5 is disabled in the sub light-emitting element drive device 1_S.

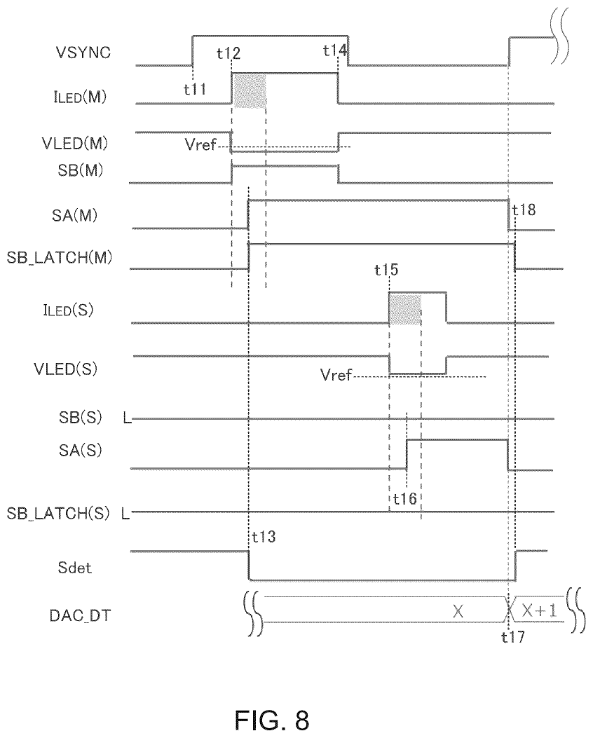

Next, operations of a system according to this embodiment are illustrated. FIG. 8 is a timing chart showing a first operation example in a system using the light-emitting element drive device 1 according to this embodiment. FIG. 8 is a case example corresponding to the case example related to the comparative example shown in FIG. 5 described above.

Furthermore, in FIG. 8, in order from the top, the synchronization signal VSYNC, the drive current I_{LED}(M) in the main, the terminal voltage VLED(M) of the connection terminal CH in the main, the output signal SB(M) of the comparator CP in the main, the latching signal SA(M) in the main, the latch signal SB_LATCH(M) in the main, the drive current I_{LED}(S) in the sub, the terminal voltage VLED(S) of the connection terminal CH in the sub, the output signal SB(S) of the comparator CP in the sub, the latching signal SA(S) in the sub, the latch signal SB_LATCH(S) in the sub, the terminal voltage detection signal Sdet (voltage of the terminal SUMFB), and the DAC data DAC_DT set in the FB current generation section 5 are shown.

First, the synchronization signal VSYNC rises at timing t11. The drive current I_{LED}(M) and the drive current I_{LED}(S) flow based on this rise. Herein, due to the phase shift function, the timing at which the drive current I_{LED}(M) and the drive current I_{LED}(S) flow are shifted.

After the timing t11, the drive current I_{LED}(M) in the main starts to flow at timing t12. Herein, it is assumed that the drive current I_{LED} flows from the timing t12 in all the connection terminals CH[1] to CH[n] in the main. However, a period during which the drive current I_{LED} flows may differ for each channel (the same applies hereinafter). At this time, the terminal voltage VLED(M) of the connection terminal CH in the main decreases. Herein, it is assumed that the terminal voltage VLED(M) in at least one of the connection terminals CH[1] to CH[n] is lower than the reference voltage Vref. As a result, the output signal SB(M) in the main, which is output from the comparator CP corresponding to a channel where the terminal voltage VLED(M) became lower than the reference voltage Vref, becomes high level.

The latching signal SA(M) in the main is generated to rise within a predetermined period (hatched) from the timing t12 in a state in which the drive current ILED(M) in the main flows. When the latching signal SA(M) rises (timing t13), the latch processing sections 4[1] to 4[n] in the main latch the output signals SB[1] to SB[n] using this as a trigger. Thus, the latch signal SB_LATCH(M) in the main, which latched the output signal SB(M) in the main that has become high level, rises to a high level.

As a result, the output of the OR gate 7 in the main becomes high level, the NMOS transistor M1 is turned on, and the terminal voltage detection signal Sdet falls to low level.

Subsequently, at timing t14, the drive current I_{LED}(M) in the main stops flowing (stop of drive current), the terminal voltage VLED(M) becomes equal to or higher than the reference voltage Vref, and the output signal SB(M) becomes low level. However, since it is latched, the output of the OR gate 7 continues to be at the high level, and the terminal voltage detection signal Sdet continues to be at the low level.

Subsequently, at timing t15, the drive current I_{LED}(S) in the sub starts to flow. Herein, it is assumed that the drive current I_{LED} flows from the timing t15 in all the connection terminals CH[1] to CH[n] in the sub. At this time, the terminal voltage VLED(S) of the connection terminal CH in the sub decreases. Herein, it is assumed that all the terminal voltages VLED(S) of the connection terminals CH[1] to CH[n] are equal to or higher than the reference voltage Vref. As a result, the output signal SB(S) in the sub becomes low level.

The latching signal SA(S) in the sub is generated to rise within a predetermined period (hatched) from the timing t15 in a state in which the drive current I_{LED}(S) in the sub flows. When the latching signal SA(S) rises (timing t16), the latch processing sections 4[1] to 4[n] in the sub latch the output signals SB[1] to SB[n] using this as a trigger. Thus, the latch signal SB_LATCH(S) in the sub becomes low level. As a result, the output of the OR gate 7 in the sub becomes low level, and the NMOS transistor M1 is turned off.

Subsequently, when the synchronization signal VSYNC rises again at timing t17 (start of the next period of VSYNC), the DAC 51 in the FB current generation section 5 updates the DAC data using this as a trigger. Herein, since the terminal voltage detection signal Sdet is at a low level, the DAC data is updated to increase the analog voltage VA. As a result, the power supply voltage Vout is adjusted to increase.

The rise of the synchronization signal VSYNC is delayed by the delay circuit 6, and the delayed rise occurs at timing t18. The latch processing sections 4[1] to 4[n] release the latch using this as a trigger.

As such, in the case example shown in FIG. 8, by latching the result of monitoring an occurrence of insufficiency of the terminal voltage of the connection terminal CH in the main, the terminal voltage detection signal Sdet can be latched, so this can be reflected when updating the DAC data, which is triggered by the rise of the synchronization signal VSYNC.

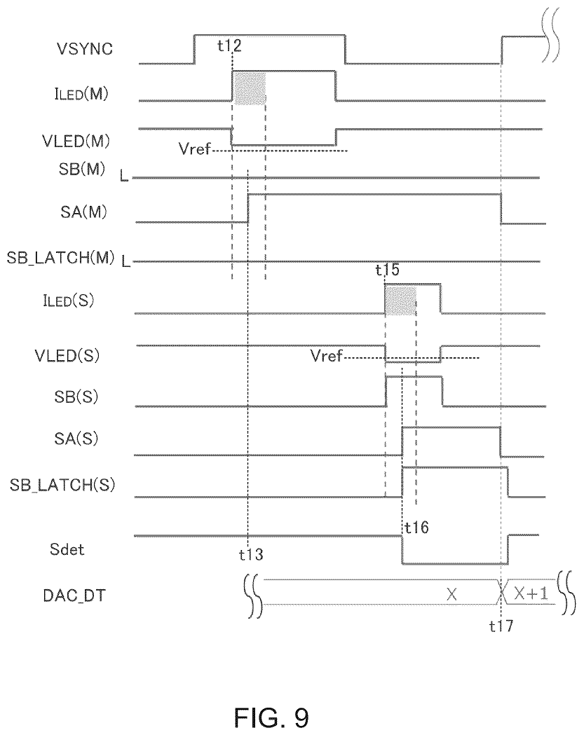

Next, FIG. 9 shows a second operation example in the system using the light-emitting element drive device 1 according to this embodiment. FIG. 9 shows a case example corresponding to the case example shown in FIG. 6 related to the comparative example described above. Herein, differences from the case example in FIG. 8 are illustrated.

In the example of FIG. 9, when the drive current I_{LED}(M) in the main flows at timing t12, the terminal voltage VLED(M) in the main decreases but remains equal to or higher than the reference voltage Vref. As a result, the output signal SB(M) in the main becomes low level, and even if the output signal SB(M) is latched at timing t13, the latch signal SB_LATCH(M) is at a low level. Thus, the output of the OR gate 7 in the main becomes low level, the NMOS transistor M1 is turned off, and the terminal voltage detection signal Sdet is at a high level.

In FIG. 9, subsequently, at timing t15, when the driving current I_{LED}(S) in the sub flows, the terminal voltage VLED(M) in the sub decreases and becomes lower than the reference voltage Vref. As a result, the output signal SB(S) in the sub becomes high level, and at timing t16, the output signal SB(S) is latched, so the latch signal SB_LATCH(S) becomes high level. Thus, the output of the OR gate 7 in the sub becomes high level, the NMOS transistor M1 is turned on, and the terminal voltage detection signal Sdet becomes low level.

As a result, at timing t17, when the synchronization signal VSNC rises, the terminal voltage detection signal Sdet is at a low level, and the DAC data is updated to increase the analog voltage VA, thereby adjusting the power supply voltage Vout to increase.

As such, in this embodiment, in each of the main and sub light-emitting element driving devices 1, the monitoring result of the terminal voltage VLED is latched when the driving current flows through its connection terminal CH, and therefore, even in case examples where there were issues in the operation of the comparative example, the insufficient voltage of the connection terminal CH can be reflected in the terminal voltage detection signal Sdet, and an adjustment of the power supply voltage Vout can be appropriately performed.

Furthermore, in the configuration of this embodiment shown in FIG. 7, since a latch processing section is provided for each comparator, even if the timing of the driving current flowing between channels is shifted, the monitoring result of the terminal voltage VLED can be latched for each channel, so an insufficiency of the terminal voltage VLED can be reflected in the terminal voltage detection signal Sdet.

### Second Embodiment

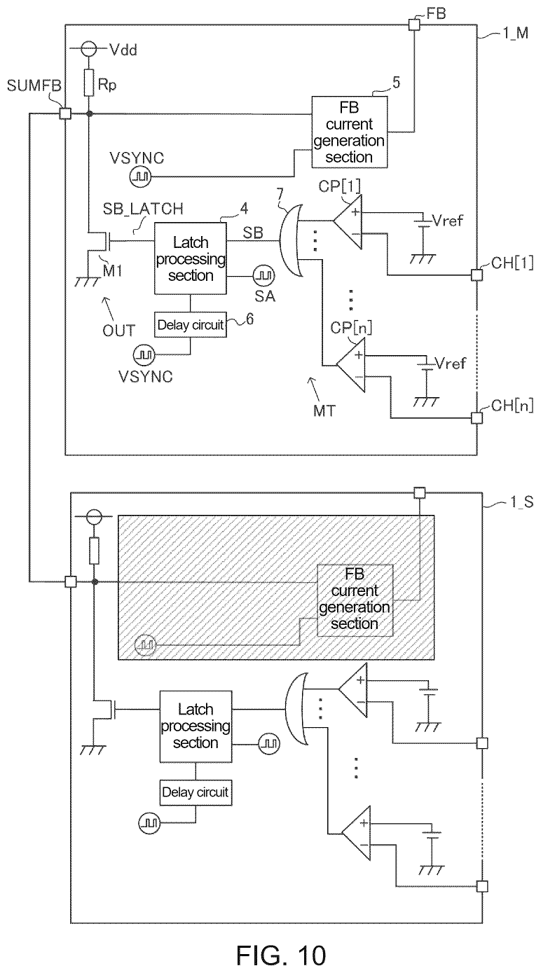

FIG. 10 is a diagram showing a configuration example of a system using the light-emitting element driving device 1 according to a second embodiment. As differences from the first embodiment, in this embodiment, the monitor section MT comprises comparators CP[1] to CP[n], an OR gate 7, one latch processing section 4, and a delay circuit 6. Outputs of each of the comparators CP[1] to CP[n] are input to the OR gate 7. The latch processing section 4 latches an output signal SB of the OR gate 7 and outputs the latch signal SB_LATCH to a gate of the NMOS transistor M1. In this embodiment, the output section OUT comprises the NMOS transistor M1 and a pull-up resistor Rp.

With such a configuration, if a condition is that the driving current flows at the same timing between channels in the same light-emitting element driving device 1, the monitoring result of the terminal voltage VLED can be latched in each of the main and sub light-emitting element driving devices 1, so an insufficiency of the terminal voltage VLED can be reflected in the terminal voltage detection signal Sdet. According to this embodiment, compared to the first embodiment, only one latch processing circuit is required, which is advantageous in terms of circuit area.

### Third Embodiment

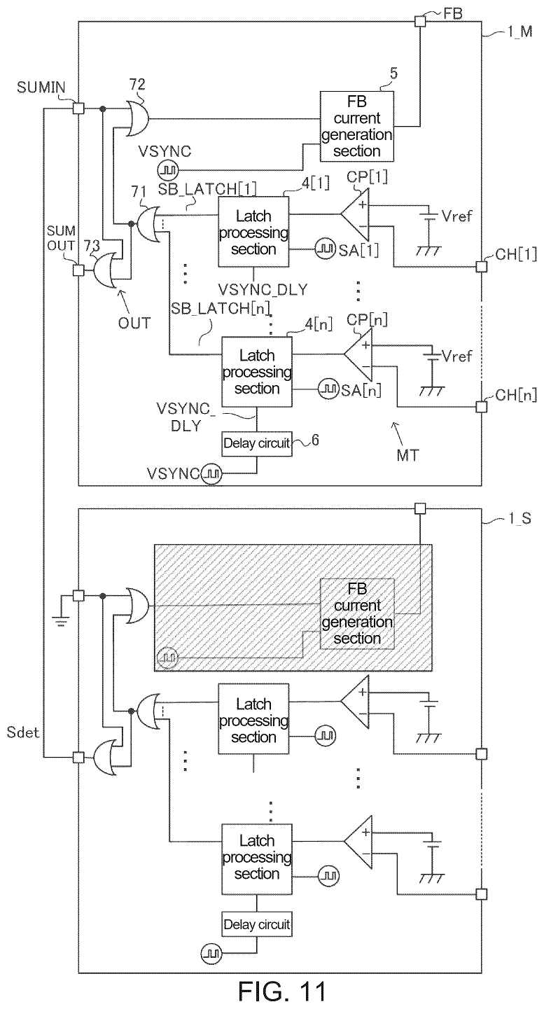

FIG. 11 is a diagram showing a configuration example of a system using the light-emitting element driving device 1 according to a third embodiment. As differences from the first embodiment, the light-emitting element driving device 1 of this embodiment comprises an output terminal SUMOUT and an input terminal SUMIN as external terminals, and furthermore comprises OR gates 71 to 73 as internal components. In this embodiment, the output section OUT comprises the OR gates 71 and 73.

The latch signals SB_LATCH[1] to SB_LATCH[n] output from each of the latch processing sections 4[1] to 4[n] are input to the OR gate 71. An output end of the OR gate 71 is connected to a first input end of the OR gate 73, and the input terminal SUMIN is connected to a second input end of the OR gate 73. An output end of the OR gate 73 is connected to the output terminal SUMOUT. An output end of the OR gate 71 is connected to a first input end of the OR gate 72, and the input terminal SUMIN is connected to a second input end of the OR gate 72. An output of the OR gate 72 is input to the FB current generation section 5.

In the configuration example of FIG. 11, to provide the main light-emitting element driving device 1_M and the sub light-emitting element driving device 1_S, the output terminal SUMOUT of the light-emitting element driving device 1_S is connected to the input terminal SUMIN of the light-emitting element driving device 1_M. Furthermore, when two or more sub light-emitting element driving devices 1_S are provided, output terminals SUMOUT are connected to input terminals SUMIN in order between the light-emitting element driving devices 1_S. That is, a daisy chain connection is performed. The input terminal SUMIN of the most terminal light-emitting element driving device 1_S is connected to a ground end.

With such a configuration, in each of the sub light-emitting element driving devices 1_S, a logical sum of the latch signals SB_LATCH[1] to SB_LATCH[n] is output from the OR gate 71, an output of the OR gate 71 and a signal at the terminal SUMIN from the ground or the previous stage are input to the OR gate 73, and a logical sum of the inputs is input as the terminal voltage detection signal Sdet from the output terminal SUMOUT to the input terminal SUMIN of the next stage. Furthermore, the FB current generation section 5 in the sub light-emitting element driving device 1_S is disabled.

In the main light-emitting element driving device 1_M, the output of the OR gate 71 and the signal from the input terminal SUMIN are input to the OR gate 72, and the logical sum of the inputs is input to the FB current generation section 5.

Thus, in at least one of the main light-emitting element driving device 1_M and the sub light-emitting element driving device 1_S, if the terminal voltage VLED of at least one connection terminal CH is insufficient, the output of the OR gate 72 in the main light-emitting element driving device 1_M becomes high level due to the corresponding latch signal SB_LATCH. In this embodiment, since the DAC 51 in the FB current generation section 5 updates the DAC data to increase the analog voltage VA when the output of the OR gate 72 is at a high level, the FB current Ifb increases and the power supply voltage Vout is adjusted to increase. As a result, the power supply voltage Vout can be appropriate adjusted.

Furthermore, the configuration of the second embodiment may be applied to this embodiment. That is, instead of the output of the OR gate 71, the latch signal SB_LATCH in the light-emitting element driving device 1 according to the second embodiment (FIG. 10) may be input to each of the OR gate 72 and the OR gate 73.

### Fourth Embodiment

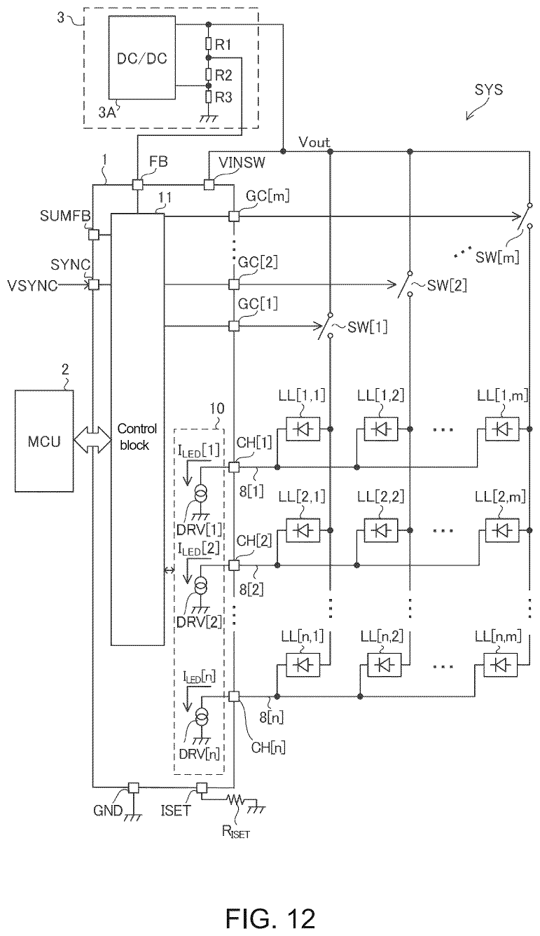

FIG. 12 is a diagram showing a configuration of a light-emitting system SYS using the light-emitting element driving device 1 according to a fourth embodiment.

Herein, it is assumed that a total of (n×m) light-emitting sections LL are provided in the light-emitting system SYS as multiple light-emitting sections LL, and the total of (n×m) light-emitting sections LL are represented by symbols “LL[1,1] to LL[n,m]”. Among the light-emitting sections LL[1,1] to LL[n,m], any one of the light-emitting sections LL is expressed as a light-emitting section LL[i,j] using any integer i satisfying “1≤i≤n” and any integer j satisfying “1≤j≤m”. The first to nth channels are set in the light-emitting system SYS and the light-emitting element driving device 1, and the light-emitting sections LL[i,1] to LL[i,m] belong to the i-th channel. Additionally, the light-emitting sections LL[1,1] to LL[n,m] can be classified into the first to m-th groups, and the light-emitting sections LL[1,j] to LL[n,j] belong to the j-th group.

The light-emitting element driving device 1 is provided with connection terminals CH[1] to CH[n] corresponding to the total number of channels. The connection terminal CH[i] belongs to the i-th channel. The connection terminal CH[i] is a light-emitting section connection terminal to which the light-emitting sections LL[i,1] to LL[i,m] belonging to the i-th channel should be connected.

Switches SW[1] to SW[m] corresponding to the total number of groups are provided in the light-emitting system SYS. The switch SW[j] corresponds to the j-th group. Each one end of the switches SW[1] to SW[m] is commonly connected to an application end of the power supply voltage Vout. The other end of the switch SW[j] is commonly connected to each high potential end (anode) of the light-emitting sections LL[1,j] to LL[n,j] belonging to the j-th group. Moreover, each low potential end of the light-emitting sections LL[i,1] to LL[i,m] belonging to the i-th channel are commonly connected to a wiring 8[i]. The wiring 8[i] is connected to the connection terminal CH[i].

The light-emitting element driving device 1 comprises a driver block 10 and a control block 11. The driver block 10 comprises current drivers DRV[1] to DRV[n]. The current driver DRV[i] belongs to the i-th channel. That is, the driver block 10 is provided with a current driver for each channel. Configurations and functions of the current drivers DRV[1] to DRV[n] are the same as each other. In each channel, the current driver DRV[i] comprises a constant current circuit and operates under a control of the control block 11 so that the drive current I_{LED}[i] flows from the connection terminal CH[i] towards a ground end during a normal light-emitting operation. The light-emitting section LL[1,j] emits light when the drive current I_{LED}[1] flows through the connection terminal CH[1] to the light-emitting section LL[1,j], and the light-emitting section LL[2,j] emits light when the drive current I_{LED}[2] flows through the connection terminal CH[2] to the light-emitting section LL[2,j]. The same applies to other drive currents and other light-emitting sections.

The control block 11 integrally controls an operation of each component within the light-emitting element driving device 1. The light-emitting element driving device 1 is provided with terminals GC[1] to GC[m] as external terminals connected to the control terminals of the switches SW[1] to SW[m]. The control block 11 can individually turn on or off the switches SW[1] to SW[m] through the terminals GC[1] to GC[m]. For example, a P-channel type MOSFET can be used as each of the switches SW[1] to SW[m]. In this case, it would suffice if the power supply voltage Vout is supplied to a source of each MOSFET as the switches SW[1] to SW[m], a drain of the MOSFET as the switch SW[j] is commonly connected to each high potential end of the light-emitting sections LL[1,j] to LL[n,j], and the control block 11 controls a gate voltage of each MOSFET as the switches SW[1] to SW[m] through the terminals GC[1] to GC[m].

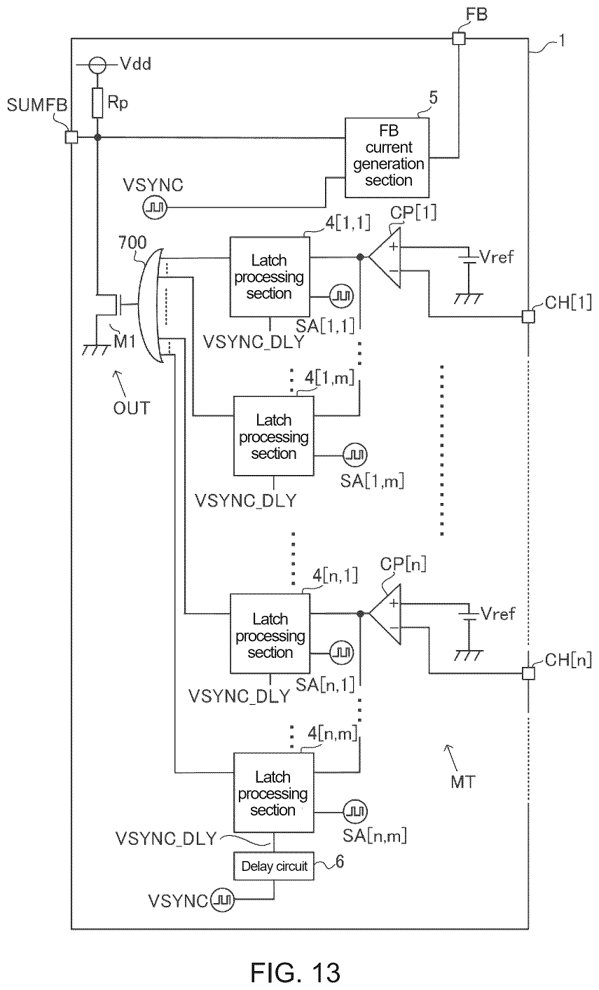

In the light-emitting element driving device 1 shown in FIG. 12, as in the embodiments described above, the terminal SUMFB and the terminal SYNC are provided. FIG. 13 is a diagram showing an internal configuration inside the control block 11 in the light-emitting element driving device 1 according to this embodiment.

As shown in FIG. 13, comparators CP[1] to CP[n] are provided for each of the connection terminals CH[1] to CH[n]. For the comparator CP[i] of the i-th channel, latch processing sections 4[i,1] to 4[i,m] are provided. In this embodiment, the monitor section MT comprises comparators CP[1] to CP[n] and latch processing sections 4[1,1] to 4[n,m]. The output section OUT comprises an OR gate 700, an NMOS transistor M1, and a pull-up resistor Rp. Furthermore, in the monitor section MT, one delay circuit 6 is provided for the latch processing sections 4[1,1] to 4[n,m].

Each of the latch processing sections 4[i,1] to 4[i,m] latches the output of comparator CP[i] using the respective latching signals SA[i,1] to SA[i,m] as triggers. Each latch result of the latch processing sections 4[1,1] to 4[n,m] is input to the OR gate 700. An output end of the OR gate 700 is connected to a gate of the NMOS transistor M1. Configurations of the NMOS transistor M1, the pull-up resistor Rp, the FB current generation section 5, and the terminal SUMFB are the same as in the first embodiment.

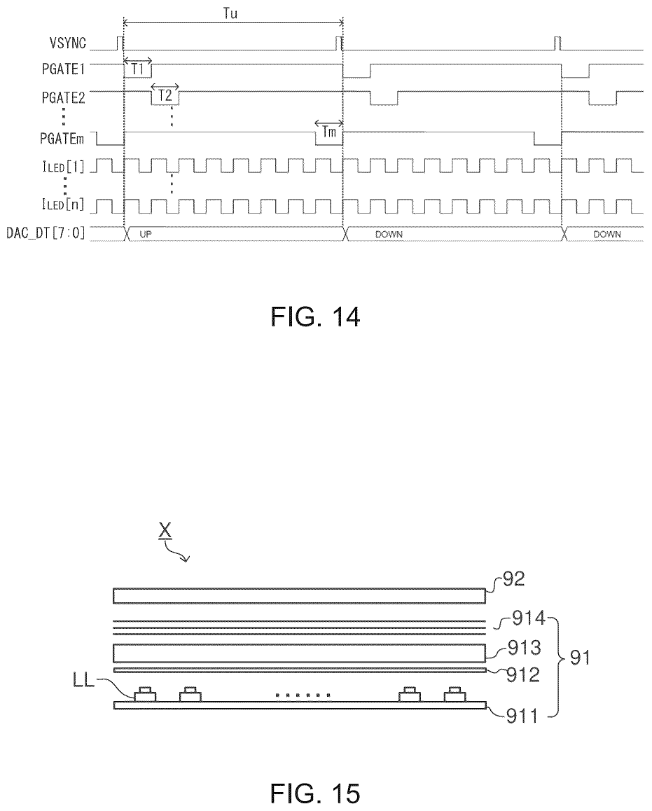

Referring to FIG. 14, a time-division light-emitting operation, which is a type of a normal light-emitting operation, is illustrated. FIG. 14 is a timing chart showing an example of the time-division light-emitting operation. In FIG. 14, in order from the top, each waveform example for the synchronization signal VSYNC, gate voltages PGATE1 to PGATEm of each of switches SW[1] to SW[m], drive currents I_{LED}[1] to I_{LED}[n], and DAC data DAC_DT are shown. Furthermore, it is assumed that the switch SW is formed of a P-channel type MOSFET.

In the time-division light-emitting operation, a unit period Tu having a predetermined time length is set. The unit period Tu is repeatedly set at a predetermined period. Moreover, by dividing each unit period Tu into m parts, the first division period T1 to the m-th division period Tm are set. In each of the first division period T1 to the m-th division period Tm, the control block 11 sets each of the gate voltages PGATE1 to PGATEm to a low level, and sets each of the switches SW[1] to SW[m] to an on state. That is, in the j-th division period, only switch SW[j] among the switches SW[1] to SW[m] is in the on state, and the other (m−1) switches are in off states (the gate voltage PGATE is at a high level). Thus, in the j-th division period, among the first to m-th group, the power supply voltage Vout is supplied only to high potential ends of the light-emitting sections LL[1,j] to LL[n,j] of the j-th group via the switch SW[j], and only the light-emitting sections LL[1,j] to LL[n,j] are able to emit light.

The control block 11 performs PWM driving of the current driver DRV for each channel in each of the first division period T1 to the m-th division period Tm. PWM is an abbreviation for pulse width modulation. In the PWM driving in each division period, the time width (in other words, the time length) during which the drive current I_{LED}[i] is supplied for each channel is controlled. That is, the time width during which the drive currents I_{LED}[1] to I_{LED}[n] are supplied is individually PWM controlled. As a result, the corresponding light-emitting section LL emits pulsed light in each division period, and an average brightness of a total of (n×m) light-emitting sections LL is individually adjusted through the control of the above time width.

In the configuration shown in FIG. 13, when the switch SW of the j-th group is in an on state and the drive current of the i-th channel is in an on state, a latch processing section [i,j] latches an output of comparator CP[i] using a latching signal SA[i,j] as a trigger. As a result, when the switch SW of the j-th group is in an on state and the drive current of the i-th channel is in an on state, if the terminal voltage of connection terminal CH[i] becomes insufficient, the output of the OR gate 700 becomes high level, and the NMOS transistor M1 is turned on.

Herein, when using multiple light-emitting element driving devices 1 according to this embodiment, as in the first embodiment described above, the terminals SUMFB of the main light-emitting element driving device 1 and the sub light-emitting element driving device 1 are connected to each other. Furthermore, the FB current generation section 5 in the sub light-emitting element driving device 1 is disabled. As a result, when the terminal voltage of the connection terminal CH becomes insufficient in either the main light-emitting element driving device 1 or the sub light-emitting element driving device 1, the signal of the terminal SUMFB is set to low level and transmitted to the FB current generation section 5 in the main light-emitting element driving device 1. Thus, the FB current generation section 5, triggered by the start of the next period of the synchronization signal VSYNC (falling timing of VSYNC in FIG. 14), updates the DAC data according to the signal at the terminal SUMFB, and adjusts the power supply voltage Vout.

### <Application to Liquid Crystal Display (LCD)>

As an example of a target for which the light-emitting element driving device according to the embodiments illustrated above is applied, a liquid crystal display device is illustrated. A configuration example of a liquid crystal display device is shown in FIG. 15. The configuration shown in FIG. 15 is a so-called direct type configuration.

The liquid crystal display device X shown in FIG. 15 comprises a backlight 91 and a liquid crystal panel 92. The backlight 91 is an illumination device (an example of a light-emitting device) that illuminates the liquid crystal panel 92 from the rear. The backlight 91 comprises a light source section 911, a phosphor sheet 912, a diffusion plate 913, and optical sheets 914.

The light source section 911 includes a light-emitting section LL and a substrate on which the light-emitting section is mounted, and the embodiments described above can be applied as the light-emitting element driving device that drives this light-emitting section LL. As in the embodiments described above, multiple light-emitting element driving devices are provided, and a light-emitting section LL is provided for each light-emitting element driving device.

The light-emitting section LL emits blue light (monochromatic) as an example. The phosphor sheet 912 transmits a part of the blue light from the light source section 911 and absorbs another part of the blue light to emit yellow light. In the backlight 91, by combining the monochromatic-type light-emitting section LL with the phosphor sheet 912, light synthesized into white is emitted. The diffusion plate 913 imparts a diffusion effect to the light from the phosphor sheet 912. The optical sheets 914 impart a predetermined optical effect to the light from the diffusion plate 913 and emit the light toward the liquid crystal panel 92.

The light-emitting section LL is arranged in a matrix pattern to match divided display areas of the liquid crystal panel 92. Since brightness of each light-emitting section LL is adjusted by PWM driving, local dimming becomes possible.

### <About In-Vehicle Displays>

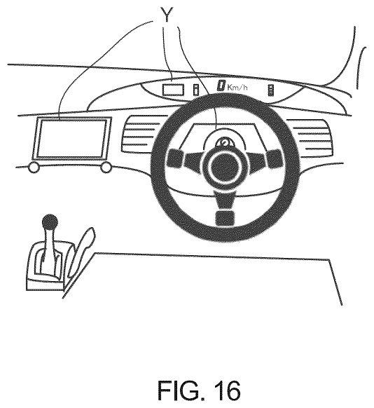

The liquid crystal display device to which the light-emitting element driving devices according to the embodiments described above are applied is particularly suitable for application to in-vehicle displays. The in-vehicle display is provided on a dashboard in front of the driver's seat of a vehicle, as shown in the in-vehicle display Y in FIG. 16, for example. The in-vehicle display Y can display various images such as car navigation information, an image captured from the rear of the vehicle, a speedometer, a tachometer, a fuel gauge, a fuel consumption meter, a shift position, etc., and can convey various information to the user.

Although in-vehicle displays are becoming larger, the light-emitting element driving devices according to the embodiments described above (particularly the fourth embodiment) make it possible to control a large number of light-emitting sections (divided display areas) with one light-emitting element driving device, thereby significantly reducing the number of light-emitting element driving devices installed and the mounting area.

### <Other>

Various technical features disclosed in this specification can be modified in various ways without departing from the spirit of the technical creation, in addition to the above embodiments. That is, the above embodiments should be considered as illustrative and not restrictive in all respects, and the technical scope of the present disclosure is not limited to the above embodiments, but should be understood to include all modifications that fall within the meaning and scope equivalent to the claims.

For example, the FB control signal generated by the FB current generation section in the embodiments described above was an FB current drawn from the node where the feedback resistor is connected in the power supply circuit, but it is not limited to this, and may be a control signal, etc. for varying a reference voltage compared with the feedback voltage in a DC/DC converter, for example.

### APPENDIX

As described above, one aspect of the present disclosure is a configuration that is a light-emitting element driving device (1), used in a light-emitting system where a light-emitting section (LL) including at least one light-emitting element of at least one channel is provided, comprising:
at least one connection terminal (CH) configured to be connectable to each of a low potential end of the light-emitting section of at least one channel;
a monitoring section (MT) that monitors a voltage of the at least one connection terminal with a driving current in an on state and holds a monitoring result;
an output section (OUT) configured to output a terminal voltage detection signal (Sdet) indicating whether the voltage of the at least one connection terminal of at least one channel is lower than a reference voltage (Vref) based on the held monitoring result;
an output terminal (SUMFB) configured to output the terminal voltage detection signal to an outside;
an input terminal (SUMFB) configured to be connectable to the output terminal of another light-emitting element driving device; and
a control signal generation section (5) configured to generate a control signal (Ifb) used for feedback control of a power supply circuit (3) configured to generate a power supply voltage (Vout) to be applied to a high potential end of the light-emitting section based on a signal input to the input terminal and the held monitoring result,
wherein the on state of the driving current is controlled during one period of a synchronization signal (VSYNC), and
the control signal generation section updates the control signal when the next period of the synchronization signal starts (first configuration, FIG. 7).

According to such a configuration, when multiple light emitting element driving devices are used, based on the voltage of the connection terminal, an adjustment of the power supply voltage supplied to the light emitting section can be more appropriately performed.

Additionally, the first configuration described above may be a configuration wherein the output terminal and the input terminal are the same terminal, and
the output section comprises a transistor (M1) with a first end connected to a pull-up resistor (Rp) and the output terminal, and a second end connected to a ground end (second configuration, FIG. 7).

Additionally, the second configuration described above may be a configuration wherein with the transistor as an N-channel type MOSFET, the output section has an open-drain configuration (third configuration).

Additionally, the first configuration described above may be a configuration wherein the output terminal (SUMOUT) and the input terminal (SUMIN) are separate terminals, and
the output section comprises a first logic circuit (71, 73) configured for the held monitoring result and a signal from the input terminal to be input and to output the terminal voltage detection signal (fourth configuration, FIG. 11).

Additionally, the fourth configuration described above may be a configuration wherein the first logic circuit comprises:
a first OR gate (71) configured for the held monitoring result to be input; and
a second OR gate (73) configured for an output of the first OR gate and a signal of the input terminal to be input and to output the terminal voltage detection signal (fifth configuration).

Additionally, any one of the first to fifth configurations described above may be a configuration wherein the monitoring section comprises:
a comparator (CP) configured to compare a voltage of the at least one connection terminal with a reference voltage; and
a latch processing section (4) configured to latch an output of the comparator using a latching signal (SA) as a trigger (sixth configuration).

Additionally, the sixth configuration described above may be a configuration wherein the at least one channel comprises multiple channels, the at least one connection terminal comprises multiple connection terminals, and the comparator (CP[1] to CP[n]) is provided for each channel of the connection terminals (seventh configuration).

Additionally, the seventh configuration described above may be a configuration wherein the latch processing section (4[1] to 4[n]) is provided for each channel of the connection terminals (eighth configuration, FIG. 7).

Additionally, the seventh configuration described above may be a configuration wherein the number of the latch processing section (4) provided for the channels is one, and
the monitoring section comprises a second logic circuit (7) configured for each output of a plurality of the comparators to be input and to output an output signal to the latch processing section (ninth configuration, FIG. 10).

Additionally, any one of the sixth to ninth configurations described above may be a configuration wherein the monitoring section comprises a delay circuit (6) configured to delay the synchronization signal, and
the latch processing section releases a latch based on the delayed synchronization signal (tenth configuration).

Additionally, any one of the first to tenth configurations described above may be a configuration wherein the at least one channel comprises multiple channels, and the at least one connection terminal comprises multiple connection terminals provided for the channels,
the light-emitting element driving device comprises a current driver (DRV) provided for each channel of the connection terminals,
in the light-emitting system, multiple switches (SW), connected between an application end of the power supply voltage and a high potential end of the light-emitting section of each channel, and configured to be controlled to be turned on/off by the light-emitting element driving device, are provided, and
the monitoring section monitors a voltage of the connection terminals when the current driver is in an on state and the switch is in an on state (eleventh configuration, FIG. 12, FIG. 13).

Additionally, any one of the first to eleventh configurations described above may be a configuration wherein the control signal generation section comprises a DA converter (51) configured to update digital data when the next period of the synchronization signal starts, and
the control signal is updated based on an analog signal (VA) output from the DA converter (twelfth configuration, FIG. 4).

Additionally, the twelfth configuration described above may be a configuration wherein the power supply circuit comprises a feedback resistor (R1, R2, R3) connected between an application end of the power supply voltage and a ground end, and
the control signal generation section comprises a constant current circuit (52) configured to generate a current signal (Ifb) drawn from a node (N1) where the feedback resistors are connected to each other, as the control signal, based on the analog signal (thirteenth configuration).

Additionally, one aspect of the present disclosure is a light emitting system, comprising the light-emitting element driving device of any one of the first to thirteenth configurations described above provided in plurality; the light-emitting section; and the power supply circuit (fourteenth configuration).

Additionally, one aspect of the present disclosure is a backlight (91), comprising:
the light-emitting element driving device of any one of the first to thirteenth configurations described above provided in plurality;
a light source section (911) comprising the light-emitting section arranged in a matrix pattern; and
at least one optical member (912 to 914) into which light emitted from the light source section is incident (fifteenth configuration).

Additionally, one aspect of the present disclosure is a display device (X), comprising:
the backlight of the fifteenth configuration described above; and
a display panel (92) into which light emitted from the backlight is incident.

### INDUSTRIAL APPLICABILITY

The present disclosure can be utilized, for example, in-vehicle displays.

1. A light-emitting element driving device, used in a light-emitting system where a light-emitting section including at least one light-emitting element of at least one channel is provided, comprising:
at least one connection terminal configured to be connectable to each of a low potential end of the light-emitting section of at least one channel;
a monitoring section that monitors a voltage of the at least one connection terminal with a driving current in an on state and holds a monitoring result;
an output section configured to output a terminal voltage detection signal indicating whether the voltage of the at least one connection terminal of at least one channel is lower than a reference voltage based on the held monitoring result;
an output terminal configured to output the terminal voltage detection signal to an outside;
an input terminal configured to be connectable to the output terminal of another light-emitting element driving device; and
a control signal generation section configured to generate a control signal used for feedback control of a power supply circuit configured to generate a power supply voltage to be applied to a high potential end of the light-emitting section based on a signal input to the input terminal and the held monitoring result,
wherein the on state of the driving current is controlled during one period of a synchronization signal, and
the control signal generation section updates the control signal when the next period of the synchronization signal starts.

2. The light-emitting element driving device of claim 1, wherein the output terminal and the input terminal are the same terminal, and
the output section comprises a transistor with a first end connected to a pull-up resistor and the output terminal, and a second end connected to a ground end.

3. The light-emitting element driving device of claim 2, wherein with the transistor as an N-channel type MOSFET, the output section has an open-drain configuration.

4. The light-emitting element driving device of claim 1, wherein the output terminal and the input terminal are separate terminals, and
the output section comprises a first logic circuit configured for the held monitoring result and a signal from the input terminal to be input and to output the terminal voltage detection signal.

5. The light-emitting element driving device of claim 4, wherein the first logic circuit comprises:
a first OR gate configured for the held monitoring result to be input; and
a second OR gate configured for an output of the first OR gate and a signal of the input terminal to be input and to output the terminal voltage detection signal.

6. The light-emitting element driving device of claim 1, wherein the monitoring section comprises:
a comparator configured to compare a voltage of the at least one connection terminal with a reference voltage; and
a latch processing section configured to latch an output of the comparator using a latching signal as a trigger.

7. The light-emitting element driving device of claim 6, wherein the at least one channel comprises multiple channels, the at least one connection terminal comprises multiple connection terminals, and the comparator is provided for each channel of the connection terminals.

8. The light-emitting element driving device of claim 7, wherein the latch processing section is provided for each channel of the connection terminals.

9. The light-emitting element driving device of claim 7, wherein a number of the latch processing section provided for the channels is one, and
the monitoring section comprises a second logic circuit configured for each output of a plurality of the comparators to be input and to output an output signal to the latch processing section.

10. The light-emitting element driving device of claim 6, wherein the monitoring section comprises a delay circuit configured to delay the synchronization signal, and
the latch processing section releases a latch based on the delayed synchronization signal.

11. The light-emitting element driving device of claim 1, wherein the at least one channel comprises multiple channels, and the at least one connection terminal comprises multiple connection terminals provided for the channels,
the light-emitting element driving device comprises a current driver provided for each channel of the connection terminals,
in the light-emitting system, multiple switches, connected between an application end of the power supply voltage and a high potential end of the light-emitting section of each channel, and configured to be controlled to be turned on/off by the light-emitting element driving device, are provided, and
the monitoring section monitors a voltage of the connection terminals when the current driver is in an on state and the switch is in an on state.

12. The light-emitting element driving device of claim 1, wherein the control signal generation section comprises a DA converter configured to update digital data when the next period of the synchronization signal starts, and
the control signal is updated based on an analog signal output from the DA converter.

13. The light-emitting element driving device of claim 12, wherein the power supply circuit comprises a feedback resistor connected between an application end of the power supply voltage and a ground end, and
the control signal generation section comprises a constant current circuit configured to generate a current signal drawn from a node where the feedback resistors are connected to each other, as the control signal, based on the analog signal.

14. A light-emitting system, comprising:
the light-emitting element driving device of claim 1 provided in plurality;
the light-emitting section; and the power supply circuit.

15. A backlight, comprising:
the light-emitting element driving device of claim 1 provided in plurality;
a light source section comprising the light-emitting section arranged in a matrix pattern; and
at least one optical member into which light emitted from the light source section is incident.

16. A display device, comprising:
the backlight of claim 15; and
a display panel into which light emitted from the backlight is incident.
